(19) United States
(12) Patent Application Publication
(10) Pub. No.: US 2024/0186522 A1
(43) Pub. Date: Jun. 6, 2024

(54) COMPOSITION FOR ELECTRODES

(71) Applicant: SOLVAY SPECIALTY POLYMERS ITALY S.P.A., Bollate (Milano) (IT)

(72) Inventors: Azzurra Agostini, Milan (IT); Rosita Lissette Pena Cabrera, Bergamo (IT); Mirko Mazzola, Milan (IT); Giulio Brinati, Milan (IT); Bradley Lane Kent, Woolwich Township, NJ (US); Marco Dossi, Milan (IT)

(73) Assignee: SOLVAY SPECIALTY POLYMERS ITALY S.P.A., Bollate (Milano) (IT)

(21) Appl. No.: 18/552,095

(22) PCT Filed: Mar. 22, 2022
(86) PCT No.: PCT/EP2022/057481

§ 371 Date: Sep. 22, 2023

Related U.S. Application Data
(60) Provisional application No. 63/164,063, filed on Mar. 22, 2021.

(30) Foreign Application Priority Data
May 3, 2021 (EP) 21171892.9

(51) Int. Cl. H01M 4/62; C08F 214/22; H01M 4/02; H01M 4/04; H01M 4/136; H01M 4/1397; H01M 4/58

(52) U.S. Cl. CPC H01M 4/623; C08F 214/225; H01M 4/0404; H01M 4/136; H01M 4/1397; H01M 4/5825; C08F 2800/10; H01M 2004/028

(57) ABSTRACT

The present invention pertains to electrode-forming compositions, comprising an electro-active material and a VDF based polymer comprising at least 70% by moles of recurring units derived from VDF, less than 0.9% by moles of recurring units derived from monomers comprising a functional group selected from carbonylic, carboxylic, sulfonic, sulfinic, phosphonic, hydroxy, —SH, ester or mixtures thereof, having a TM between 130° C. and 180° C. and comprising less than 700 mmoles/kg of chain ends —CF₂H and —CF₂CH₃. The composition has good adhesion and is physically stable over time. The invention also relates to the use of said electrode-forming compositions in a process for the manufacture of electrodes, to said electrodes and to electrochemical devices such as secondary batteries comprising said electrodes.

### TECHNICAL FIELD

This application claims priority to the provisional application filed at the United States Patent Office on 22 Mar. 2021 with Nr 63/164063, and to the patent application 21171892.9 filed at the European Patent Office on 3 May 2021, the whole content of each of these applications being incorporated herein by reference for all purposes.

The present invention pertains to electrode-forming compositions, to the use of said electrode-forming compositions in a process for the manufacture of electrodes, to said electrodes and to electrochemical devices such as secondary batteries comprising said electrodes.

### BACKGROUND ART

Electrochemical devices such as secondary batteries typically comprise a positive electrode, a negative electrode, a separator and an electrolyte.

Electrodes for secondary batteries are usually produced by applying an electrode forming composition via e.g. casting, printing or roll coating onto a metal substrate also known as “current collector”. The electrode forming compositions are typically formed by mixing a binder with a powdery electro-active material and optionally other ingredients such as solvents, materials to enhance conductivity and/or control viscosity. The binder is a key component of electrodes because it has the role of ensuring good adhesion to the current collector and to the electro active compounds, thus allowing the electro active material to transfer electrons as required. Current commercial batteries typically use graphite as electro active compound in the anode, and mixed oxides containing lithium as electro active compounds in the cathode. The electrode forming composition is typically applied on the current collector and dried to remove any solvent. The resulting sheet is normally calendered or otherwise mechanically treated and rolled. Individual electrodes are then cut out from this sheet.

Fluoropolymers are known in the art to be suitable as binders for the manufacture of electrodes for use in electrochemical devices such as secondary batteries.

In the related art, vinylidene fluoride polymers (PVDF) have been used as electrode binder in secondary batteries. Generic PVDF homopolymers have poor adhesion to metal. In order to overcome this problem VDF based copolymers have been proposed comprising, in addition to recurring units derived from VDF, a small amount of recurring units derived from comonomers carrying polar groups. As an example, in WO 2008/129041 it has been demonstrated that including a small amount of recurring units derived from an acrylic monomer improves the adhesion to metal of VDF based polymers.

On the other hand it has been observed that, in some cases, VDF copolymers carrying polar groups such as ionic groups (carboxylic, sulfonic, sulfinic, phosphonic), carbonyl groups (aldehydes, ketones, esters), —SH groups or hydroxyl groups, when used as a binder in certain electrode forming compositions, may cause the composition to turn to a solid elastic “jelly like” material which cannot be spread and applied to a current collector with the usual methods and equipment commonly used in the industry for this purpose (e.g. casting, printing or roll coating).

Current equipment for the preparation of electrodes requires the electrode forming compositions to be spreadable or extrudable as a viscous fluid. Therefore an electrode forming composition in solidified form cannot be used with such equipment. This “solidification” effect has been observed with a broad variety of active materials and solvents although the use of a lower amount of solvent (which is in general desirable for environmental and costs reasons) and of electro-active materials including LiFePO₄ appears to have an effect in causing the solidification of the composition more often.

In some cases the “solidification” of the composition occurs immediately when preparing the electrode forming composition. In other cases the “solidification” has been observed to develop slowly with time, starting with a steep increase in viscosity of the electrode forming composition over time. In certain cases, even if the composition does not turn into a solid jelly, its viscosity increases is such that the electrode forming compositions cannot be processed anymore with the conventional equipment. This is also a problem because electrode forming compositions, during electrode manufacturing, should be stable enough to be stored at least 7 days while maintaining their physical properties.

There is therefore a need for electrode forming compositions which do not solidify, which maintain stable viscosity over time and which have good adhesion on metals.

The present invention addresses this need by providing a new electrode forming composition which comprises polymeric binders based on selected VDF based polymers which, while being free, or having a reduced number, of polar groups, also have a low amount of —CF₂H and —CF₂CH₃ chain ends. Such electrode forming compositions surprisingly have good adhesion and are physically stable over time in a variety of conditions.

### SUMMARY OF INVENTION

The present invention relates to an electrode-forming composition comprising:
(a) one or more VDF based polymers wherein:
   (i) said VDF based polymers comprise at least 70% by moles of recurring units, based on the total amount of recurring units of said polymers, derived from vinylidene fluoride (VDF);
   (ii) said VDF based polymers comprise less than 0.9% by moles of recurring units, based on the total amount of recurring units of said polymers, comprising a functional group selected from carbonylic, carboxylic, sulfonic, sulfinic, phosphonic, hydroxy, —SH, ester or mixtures thereof;
   iii) said VDF based polymers have a melting temperature Tm comprised between 130 and 180° C.
   (iv) said VDF based polymers have a total number of chain ends —CF₂H and —CF₂CH₃ as measured via NMR of less than 70 mmoles/Kg
(b) one or more electro-active materials.

In another aspect, the present invention relates to a process for the manufacture of an electrode using an electrode forming composition as described above, said process comprising:
(i) providing a metal substrate having at least one surface;
(ii) providing an electrode-forming composition as defined above;
(iii) applying the composition provided in step (ii) onto the at least one surface of the metal substrate provided in step (i), thereby providing an assembly comprising a metal substrate coated with said composition onto the at least one surface;
(iv) drying the assembly provided in step (iii).

In a further aspect the present invention relates to an electrode obtainable from such a process.

In a further aspect the present invention relates to an electrochemical device comprising said electrode.

### DETAILED DESCRIPTION OF THE INVENTION

As mentioned above, the present invention relates to an electrode-forming composition comprising a VDF based polymer and an electro active material.

For “VDF based polymer” it is intended a polymer or copolymer comprising a majority of recurring units derived from 1,1, difluoro ethylene (vinylidene fluoride, or VDF). VDF based polymers suitable for use in the present invention comprise at least 70%, preferably at least 80%, more preferably at least 90%, most preferably at least 94% by moles of recurring units derived from VDF. All percentages are based on the total amount of recurring units in the polymer. Particularly preferred are homopolymers of VDF.

VDF based polymers and copolymers for use in the present invention must have a relatively low amount of polar functional groups. More specifically, VDF based polymers and copolymers usable in the present invention comprise less than 0.9%, preferably less than 0.6%, more preferably less than 0.4%, even more preferably less than 0.2% by moles of recurring units comprising a functional group selected from carbonylic, carboxylic, sulfonic, sulfinic, phosphonic, hydroxy, —SH, ester or mixtures thereof. All percentages are based on the total amount of recurring units in the polymer. Homopolymers of VDF are naturally free from recurring units including such polar groups with the possible exception of their chain ends, which, as known to the skipped person, may be influenced by the initiators and chain transfer agents used during polymerization. VDF based copolymers may also include recurring units derived from monomers carrying such polar groups. For the purpose of the calculation of the total molar amount of polar groups, chain ends including one of the listed functional groups are counted as one recurring unit. Most preferably VDF based polymers for use in the present invention are free from recurring units derived from monomers comprising such functional groups.

Besides this requirement for a low amount of polar functional groups as described above, VDF based copolymers suitable for use in the present invention may include recurring units from additional monomers. The choice of such additional monomers is not particularly limited (except for monomers comprising the polar groups mentioned above).

Non limitative examples of suitable additional monomers are notably:
(i) C₂-C₈ perfluoroolefins, such as tetrafluoroethylene (TFE) and hexafluoropropylene (HFP);
(ii) hydrogen-containing C₂-C₈ olefins different from VDF, such as vinyl fluoride (VF), trifluoroethylene (TrFE), perfluoroalkyl ethylenes of formula CH₂═CH—R_{f}, wherein R_{f} is a C₁-C₆ perfluoroalkyl group;

(iii) C₂-C₈ chloro and/or bromo and/or iodo-fluoroolefins such as orotrifluoroethylene (CTFE);
(iv) (per)fluoroalkylvinylethers (PAVE) of formula CF₂═CFOR_{f}, wherein R_{f} is a C₁-C₆ (per)fluoroalkyl group, e.g. —CF₃, —C₂F₅, —C₃F₇;
(v) (per)fluoro-oxy-alkylvinylethers of formula CF₂═CFOX, wherein X is a C₁-C₁₂ [(per)fluoro]-oxyalkyl comprising catenary oxygen atoms, e.g. the perfluoro-2-propoxypropyl group;
(vi) (per)fluorodioxoles having formula:

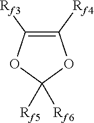

wherein R_{f3}, R_{f4}, R_{f5}, R_{f6}, equal or different from each other, are independently selected among fluorine atoms and C₁-C₆ (per)fluoroalkyl groups, optionally comprising one or more than one oxygen atom, such as notably —CF₃, —C₂F₅, —C₃F₇, —OCF₃, —OCF₂CF₂OCF₃; preferably, perfluorodioxoles;
(vii) (per)fluoro-methoxy-vinylethers (MOVE, hereinafter) having formula: CFX₂═CX₂OCF₂OR″_{f} wherein R″_{f} is selected among linear or branched C₁-C₆ (per)fluoroalkyls; C₅-C₆ cyclic (per)fluoroalkyls; and C₂-C₆ (per)fluorooxyalkyls, linear or branched, comprising from 1 to 3 catenary oxygen atoms, and X₂=F, H; preferably X₂ is F and R″_{f} is —CF₂CF₃ (MOVE1); —CF₂CF₂OCF₃ (MOVE2); or —CF₃ (MOVE3). VDF based polymers polymer for use in the present invention must also have a melting temperature Tm comprised between 130° C. and 180° C., preferably between 150° C. and 170° C., and must have a total number (a) +
(b) chain ends wherein:
(a): —CF₂H
(b)—CF₂CH₃,
as measured via NMR, of less than 70, preferably less than 60, more preferably less than 50, even more preferably less than 45, most preferably less than 40 mmoles/Kg.

Without being bound by theory it is believed that the low amount of polar groups prevents solidification of the electrode forming composition and improves its physical stability over time. However, as known from the mentioned art WO 2008/129041, the low amount or lack of polar monomers tend to impart low adhesion to metals to the composition. This drawback is offset in the present invention by selecting VDF based polymers having a relatively low number of certain chain ends. The applicant has surprisingly found that by selecting VDF based polymers having a low number of certain chain ends, the resulting electrode forming compositions has a much higher adhesion on metals than a corresponding composition using a standard VDF based polymer (see experimental section).

VDF based polymers having the required low concentration of chain ends can be prepared polymerizing VDF and the additional optional comonomers via aqueous emulsion polymerization in the presence of a redox-initiating system comprising at least one organic radical initiator as oxidising agent and at least one sulphur based reducing agent.

As known to the skilled person, a redox initiating system for the radical polymerization of monomers, is an initiator system wherein radicals are formed by introducing in the reactor at least one oxidising agent and at least one reducing agent. The redox reaction is typically very fast even at very low temperatures and it causes the formation of radicals which, in the presence of polymerizable monomers, initiate and propagate their polymerization. Continuous controlled feeding of the redox initiator (typically in the form of two separate feeds of oxidising agent and reducing agent) can sustain the polymerization reaction until its completion.

The oxidising agent, for making a VDF based polymer for use in the present invention preferably comprises, one or more compounds selected among organic radical initiators, more preferably among organic peroxides or percabonates, most preferably selected in the group comprising,: acetylcyclohexanesulfonyl peroxide; diacetyl-peroxydicarbonate; dialkylperoxydicarbonates such as diethylperoxydicarbonate, dicyclohexylperoxydicarbonate, di-2-ethylhexylperoxydicarbonate; tertbutyl-perneodecanoate; 2,2′-azobis(4-methoxy-2,4dimethylvaleronitrile); tertbutyl-perpivalate; dioctanoylperoxide; dilauroyl-peroxide; 2,2′-azobis (2,4-dimethyl-valeronitrile); tert-butylazo-2-cyanobutane; dibenzoylperoxide; tertbutyl-per-2-ethylhexanoate; tert-butylpermaleate; 2,2′-azobis(isobutyronitrile); bis(tertbutyl-peroxy)-cyclohexane; tert-butyl-peroxyisopropylcarbonate; tertbutylperacetate; 2,2′-bis (tert-butylperoxy)butane; dicumyl peroxide; di-tertamyl peroxide; di-tert-butyl peroxide; p-methane hydroperoxide; pinnae hydroperoxide; cumene hydro-peroxide; disuccinylperoxide; and tert-butyl hydroperoxide.

Organic radical initiators selected from peroxides are particularly preferred and among these tert-butyl hydroperoxide is mostly preferred. Said organic radical initiator is typically used at a concentration ranging from 0.001 to 20 wt. % based on the total weight of the polymerization medium.

Sulphur based reducing agents suitable for preparing a VDF based polymer for use in the present invention, are preferably selected from sulfites and sulfinates in their acid or salt form. More preferably are selected from compounds complying with the following formula (S-I):

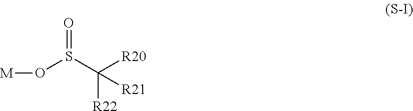

wherein
M is a hydrogen atom, an ammonium ion, a monovalent metal ion;
R20 is —OH or —N(R⁴)(R⁵) where each of R⁴ and R⁵, identical or different from one another, are hydrogen atom or linear or branched alkyl chain having from 1 to 6 carbon atoms;
R21 is hydrogen atom, linear or branched alkyl group having from 1 to 6 carbon atoms, 5- or 6-membered cycloalkyl group, 5-or 6-membered aryl group;
R22 is —COOM, —SO₃M, —C(═O)R₄, —C(═O)N(R⁴)(R⁵), —C(═O)OR₄, wherein M, R⁴ and R⁵ are as defined above, and salt thereof with at least one monovalent metal ion.

Preferably, M is hydrogen atom or a monovalent metal ion.

Preferably, said monovalent metal ion is selected from sodium and potassium.

Preferably, R20 is selected from hydroxyl or amino group.

Preferably, R21 is selected from hydrogen atom, linear or branched alkyl group having from 1 to 3 carbon atoms, and 5-or 6-membered aryl group.

Preferably, R22 is selected from —COOM, —SO₃M, and C(═O)OR₄, wherein M, R⁴ and R⁵ are as defined above.

A preferred compound complies with formula (S-I) above, wherein M is sodium, R20 is —OH, R21 is hydrogen atom and R22 is selected from —COOM, —SO₃M, and C(═O)OR₄, wherein M, R⁴ and R⁵ are as defined above.

A more preferred compound complying with formula (S-I) above is 2-hydroxy-2-sulfinatoacetic acid or its disodium salt.

In one embodiment the sulphur based reducing agent is a composition CS comprising at least 40 wt. % of a compound complying with formula (S-I) as defined above, with respect to the total weight of said composition CS.

Preferably, said composition CS comprises at most 79 wt. % of a compound complying with formula (S-I) as defined above, with respect to the total weight of said composition CS.

Preferably, said composition CS further comprises sulphurous acid or a salt thereof (also referred to as “sulfite”), such as notably sodium sulphite.

Preferably, said composition CS comprises at least 20 wt. % of said sulphurous acid or a salt thereof, with respect to the total weight of said composition CS.

Preferably, said composition CS comprises at most 40 wt. % of said sulphurous acid or a salt thereof, with respect to the total weight of said composition CS.

Preferably, said composition CS further comprises a compound [compound S₃ comprising at least one sulfonic acid group.

Preferably, said compound S₃ complies with the following formula S₃-I:

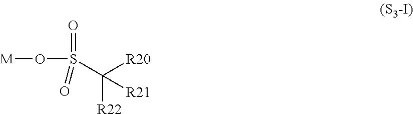

wherein M, R20, R21 and R22 have the same meaning defined above for compound of formula (S-I), and salt thereof with at least one monovalent metal ion.

Preferably, said composition CS comprises at least 1 wt. % of a compound complying with formula (S₃-I) as defined above, with respect to the total weight of said composition CS.

Preferably, said composition CS comprises at most 40 wt. % of a compound complying with formula (S₃-I) as defined above, with respect to the total weight of said composition CS.

Suitable examples of said composition CS and compound are commercially available from BRÜGGEMANN-GROUP under the trade name Bruggolite®.

During the preparation of VDF polymers suitable for use in the present invention at least a portion of the polymerization reaction, preferably at least 70%, more preferably at least 80% of the reaction even more preferably at least 90% of the reaction (measured considering the % molar conversion of monomers fed) must be conducted in the presence of an organic radical initiator and of a sulphur based reducing agent. However other initiators can be used in combination. Good results have been obtained by starting the polymerization reaction feeding a small amount of a persulphate inorganic initiator in combination with a sulphur based reducing agent, and then continuing the polymerization reaction using an organic radical initiator in combination with the sulphur based reducing agent until the polymerization reaction is complete.

Optionally, the preparation of the VDF based polymer of the invention via emulsion polymerization in the presence of a redox intiator system further comprises the use of further ingredients known in the art, such as typically surfactant(s), chain transfer agent(s) and accelerant(s).

Surfactants can be optionally used to stabilise the aqueous emulsion. Fluorinated surfactants can be used, such as notably those complying with the following formula:

R*-X^{B-}(T⁺)
wherein
R* is a C₅-C₁₆ (per)fluoroalkyl chain or a (per)fluoropolyoxyalkylenic chain,
X^{B}— is —COO— or —SO₃— , T⁺ is selected from: H⁺, NH₄⁺, an alkaline metal ion.

Among these, preferred surfactants are selected from the group comprising fluorinated surfactants, such h as: ammonium perfluoro-octanoate; (per)fluoropolyoxy-alkylenes ended with one or more carboxylic groups, optionally salified with sodium, ammonium and alkaline metals, more preferably salified with sodium; and partially fluorinated alkylsulphonates.

Preferably, said surfactant is used in an amount of from 0.05 to 5 wt. % based on the total weight of the final polymer (P).

According to an alternative and more preferred embodiment, the emulsion polymerization is performed in the absence of said fluorinated surfactant,

According to a further alternative and more preferred embodiment, the emulsion polymerization is performed in the presence of non fluorinated surfactants such as for example alkyl sulphate surfactants.

Said emulsion polymerization reaction may also be performed in the presence of a small amount of fluorinated or non fluorinated surfactants used in an amount not exceeding 100 ppm, more preferably not exceeding 50 ppm, with respect to the total weight of the final polymer (P).

If present, said optional chain transfer agent can be selected from ketones, esters, ethers or aliphatic alcohols having from 3 to 10 carbon atoms, such as acetone, ethylacetate, diethylether, methyl-ter-butyl ether, isopropyl alcohol, etc.; chloro(fluoro)carbons, optionally containing hydrogen, having from 1 to 6 carbon atoms, such as chloroform, trichlorofluoromethane; bis(alkyl)carbonates wherein the alkyl has from 1 to 5 carbon atoms, such as bis(ethyl)carbonate, bis(isobutyl)-carbonate. The chain transfer agent can be fed to the polymerization medium at the beginning, continuously or in discrete amounts (step-wise) during the polymerization, continuous or stepwise feeding being preferred.

If present , said accelerant is selected from the group comprising, more preferably consisting of: organic onium compounds, amino-phosphonium derivatives, phosphoranes and imine compounds.

Examples of accelerants that may be used include: quaternary ammonium or phosphonium salts as notably described in EP 335705 A (MINNESOTA MINING) and U.S. Pat. No. 3,876,654 (DUPONT); aminophosphonium salts as notably described in U.S. Pat. No. 4,259,469 (MONTEDISON S.P.A.); phosphoranes as notably described in U.S. Pat. No. 3,752,787 (DUPONT); imine compounds as described in EP 0120462 A (MONTEDISON S.P.A.) or as described in EP 0182299 A (ASAHI CHEMICAL)

Quaternary phosphonium salts and aminophosphonium salts are preferred, and more preferably salts of tetrabutylphosphonium, tetrabutyl ammonium, and of 1,1-diphenyl- 1-benzyl-N-diethyl-phosphoramine of formula:

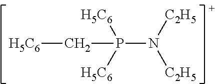

Said accelerant is preferably used in an amount from 0.05 phr and up to 10 phr, based on the total weight of polymer (P).

Further to the above, the preparation of the VDF based polymers of the invention is optionally performed using other conventional additives, such as reinforcing fillers (e.g., carbon black), thickeners, pigments, antioxidants, stabilizers and the like.

The preparation method for the VDF based polymers of the present invention can be preferably performed in continuous, or semi-batch or batch at a temperature that can be selected from the person skilled in the art on the basis of the choice of organic peroxide. Preferably, the method of the present invention is performed at a temperature from 40° C .to 120° C., more preferably from 50° C. to 100° C.

The method of the present invention is preferably performed at a pressure between 10 and 60 bars, more preferably from 25 to 55 bars.

The process described provides a VDF based polymer suitable for use in the present invention in the form of an aqueous dispersion. Typically for use in the electrode forming composition of the invention the VDF based polymer is recovered in powder form from the dispersion using any suitable method or combination of methods known in the art e.g. via filtration, coagulation, concentration, spray drying . The resulting powder can be optionally washed with demineralized water and dried.

### Electro-Active Material

The electrode forming compositions of the present invention include one or more electro-active materials. For the purpose of the present invention, the term “electro-active material” is intended to denote a compound which is able to incorporate or insert into its structure and substantially release therefrom alkaline or alkaline-earth metal ions during the charging phase and the discharging phase of an electrochemical device. The electro active material is preferably able to incorporate or insert and release lithium ions.

The nature of the electro active material in the electrode forming composition of the invention depends on whether said composition is used in the manufacture of a positive electrode or a negative electrode.

In the case of forming a positive electrode for a Lithium-ion secondary battery, the electro active compound may comprise one or more a Lithium containing compounds selected from:
(i) metal chalcogenides of formula LiMQ₂, wherein M is at least one metal selected from transition metals, preferably from Co, Ni, Fe, Mn, Cr and V and Q is a chalcogen preferably selected from as O or S. Among these, it is preferred to use a lithium-based metal oxide of formula LiMO₂, wherein M is the same as defined above. Particularly preferred examples thereof may include LiCoO₂, LiNiO₂, LiNiₓCO₁₋ₓO₂ (0<x<1) and spinel-structured LiMn₂O₄.
(ii) a lithiated or partially lithiated transition metal oxyanion-based electro-active materials of formula M1M2(JO₄)_{f}E_{1-f}, wherein M1 is lithium, which may be partially substituted by one or more other alkali metal representing less than 20% of the M1 metals, M2 is a transition metal at the oxidation level of +2 selected from Fe, Mn, Ni or mixtures thereof, which may be partially substituted by one or more additional metals at oxidation levels between +1 and +5 and representing less than 35% of the M2 metals, JO4 is any oxyanion wherein J is either P, S, V, Si, Nb, Mo or a combination thereof, E is a fluoride, hydroxide or chloride anion, f is the molar fraction of the JO₄ oxyanion, generally comprised between 0.75 and 1.

The M₁M₂(JO₄)_{f}E_{1-f} electro-active material as defined above is preferably phosphate-based and may have an ordered or modified olivine structure.

More preferably, the electro active compound in the case of forming a positive electrode has formula Li₃₋ₓM′_{y}M″_{2-y}(JO₄)₃ wherein 0≤x≤3, 0≤y≤2, M′ and M″ are the same or different metals, at least one of which being a transition metal, JO₄ is preferably PO4 which may be partially substituted with another oxyanion, wherein J is either S, V, Si, Nb, Mo or a combination thereof. Still more preferably, the electro active compound is a phosphate-based electro-active material of formula Li(FeₓMn₁₋ₓ)PO₄ wherein 0≤x≤1, wherein x is preferably 1 (that is to say, lithium iron phosphate of formula LiFePO₄).
(iii) lithium-containing complex metal oxides of general formula (III)

LiNiₓM1_{y}M2_{z}Y₂ (III)
wherein M1 and M2 are the same or different from each other and are transition metals selected from Co, Fe, Mn, Cr and V, 0.5≤x≤1, wherein y+z=1−x, and Y denotes a chalcogen, preferably selected from O and S.

The electro active material in this embodiment is preferably a compound of formula (III) wherein Y is O. In a further preferred embodiment, M1 is Mn and M2 is Co or M1 is Co and M2 is Al.

Examples of such active materials include LiNiₓMn_{y}Co_{z}O₂, herein after referred to as NMC, and LiNiₓCo_{y}Al_{z}O₂, herein after referred to as NCA.

Specifically with respect to LiNiₓMn_{y}Co_{z}O₂, varying the content ratio of manganese, nickel, and cobalt can tune the power and energy performance of a battery.

In this embodiment of the present invention, the compound AM is preferably a compound of formula (III) as above defined, wherein 0.5≤x≤1, 0.1≤y≤0.5, and 0≤z≤0.5.

Non limitative examples of suitable electro active materials for positive electrode of formula (III) include, notably:

LiNi_{0.5}Mn_{0.3}Co_{0.2}O₂,

LiNi_{0.6}Mn_{0.2}Co_{0.2}O₂,

LiNi_{0.8}Mn_{0.1}Co_{0.1}O₂,

LiNi_{0.8}Co_{0.05}Al_{0.05}O₂,

LiNi_{0.8}Co_{0.2}O₂,

LiNi_{0.8}Co_{0.05}Al_{0.05}O₂,

LiNi_{0.6}Mn_{0.2}Co_{0.2}O₂,

LiNi_{0.8}Mn_{0.1}Co_{0.1}O₂,

LiNi_{0.9}Mn_{0.05}Co_{0.05}O₂.

Among these the compounds:

LiNi_{0.8}Co_{0.05}Al_{0.05}O₂,

LiNi_{0.6}Mn_{0.2}Co_{0.2}O₂,

LiNi_{0.8}Mn_{0.1}Co_{0.1}O₂,

LiNi_{0.9}Mn_{0.05}Co_{0.05}O₂.

are particularly preferred.

In the case of forming a negative electrode for a Lithium-ion secondary battery, the electro active compounds may preferably comprise one or more carbon-based materials and/or one or more silicon-based materials.

In some embodiments, the carbon-based materials may be selected from graphite, such as natural or artificial graphite, graphene, or carbon black. These materials may be used alone or as a mixture of two or more thereof. The carbon-based material is preferably graphite.

The silicon-based compound may be one or more selected from the group consisting of chlorosilane, alkoxysilane, aminosilane, fluoroalkylsilane, silicon, silicon chloride, silicon carbide and silicon oxide. More particularly, the silicon-based compound may be silicon oxide or silicon carbide.

When present in the electro active compounds, the silicon-based compounds are comprised in an amount ranging from 1 to 60% by weight, preferably from 5 to 20% by weight with respect to the total weight of the electro active compounds.

The benefits provided by the particularly selected VDF based polymers in the present invention are particularly evident when in the presence of electro-active materials having general formula:

Li(FeₓMn₍₁₋ₓ₎)PO₄ wherein 0≤x≤1,

and in particular of LifePO4. Therefore electrode forming compositions for forming positive electrodes and comprising these Li(Fe/MN)PO₄ based electro-active materials are particularly preferred for the present invention.

The electrode forming compositions of the invention optionally comprise one or more solvents.

The solvent for a negative electrode forming composition may comprise and can preferably be water. This allows reducing the overall use of organic solvents with a consequent reduction of costs, reduction of flammable material and reduced environmental impact.

The solvent in positive electrode forming composition comprises one or more organic solvents, preferably polar solvents, examples of which may include: N-methyl-2-pyrrolidone, N,N-dimethylformamide, N, N-dimethylacetamide, dimethylsulfoxide, hexamethylphosphamide, dioxane, tetrahydrofuran, tetramethylurea, triethyl phosphate, and trimethyl phosphate. These organic solvents may be used singly or in mixture of two or more species.

The electrode forming compositions of the present invention typically comprise from 0.5% by weight to 10% by weight, preferably from 0.7% by weight to 5% by weight of polymer. The compositions also comprise from 80% by weight to 99% by weight of electro active material(s), all percentages being weight percentages over the total solid content of composition.

By the term “total solid content” it is intended “all the ingredients of the electrode forming composition of the invention excluding the solvent”. In general in the electrode forming compositions of the present invention the solvent is present in an amount of from 10% by weight to 90% by weight of the total amount of the composition (C). In particular for negative electrode forming composition the solvent is preferably present in an amount of from 25% by weight to 75% by weight, more preferably from 30% by weight to 60% by weight of the total amount of the composition.

For positive electrode forming compositions the solvent is preferably present in an amount of from 5% by weight to 60% by weight, more preferably from 15% by weight to 40% by weight of the total amount of the composition.

The electrode forming compositions of the present invention may further include one or more optional conductive agents in order to improve the conductivity of a resulting electrode made from the composition of the present invention. Conducting agents for batteries are known in the art.

Examples thereof may include: carbonaceous materials, such as carbon black, graphite fine powder carbon nanotubes, graphene, or fiber, or fine powder or fibers of metals such as nickel or aluminum.

When present, the conductive agent is different from the carbon-based material described above.

The amount of optional conductive agent is preferably from 0 to 30% by weight with respect to the total solids in the electrode forming composition. In particular, for positive electrode forming compositions the optional conductive agent is typically from 0% by weight to 10% by weight, more preferably from 0% by weight to 5% by weight of the total amount of the solids within the composition.

For negative electrode forming compositions which are free from silicon based electro active compounds the optional conductive agent is typically from 0% by weight to 5% by weight, more preferably from 0% by weight to 2% by weight of the total amount of the solids within the composition, while for negative electrode forming compositions comprising silicon based electro active compounds it has been found to be beneficial to introduce a larger amount of optional conductive agent, typically from 5% by weight to 20% by weight of the total amount of the solids within the composition.

Electrode forming compositions are typically prepared by dissolving or dispersing the binder polymer(s), namely, in the context of the present invention, the one or more VDF based polymers, in a suitable solvent such as e.g. NMP, and forming a slurry adding the electro-active material and the other optional ingredients under suitable mixing. As mentioned above, electrode forming compositions are typically applied onto the current collector using procedures such as casting, printing and roll coating. Therefore the viscosity of the composition must be preferably controlled in order to be in a range which is acceptable for the mentioned equipment. As known to the skilled persons, the amount of solvent is typically a factor which can be used to control the viscosity of electrode forming compositions.

The electrode-forming composition of the invention can be used in a process for the manufacture of an electrode, said process comprising:
(i) providing a metal substrate having at least one surface;
(ii) providing an electrode-forming composition according to the present invention,
(iii) applying the electrode forming composition provided in step (ii) onto the at least one surface of the metal substrate provided in step (i), thereby providing an assembly comprising a metal substrate coated with said composition onto the at least one surface;
(iv) drying the assembly provided in step (iii).

The metal substrate is generally a foil, mesh or net made from a metal, such as copper, aluminium, iron, stainless steel, nickel, titanium or silver.

Under step (iii) of the process of the invention, the electrode forming composition is applied onto at least one surface of the metal substrate typically by any suitable procedures such as casting, printing and roll coating.

Optionally, step (iii) may be repeated, typically one or more times, by applying the electrode forming composition provided in step (ii) onto the assembly provided in step (iv).

Step (iv) is suitably carried out at a temperature comprised between 50° C. to 200° C., preferably between 80° C. to 180° C., for a time of between 5 minutes and 48 hours, preferably between 30 minutes and 24 hours.

The assembly obtained at step (iv) may be further subjected to a compression step, such as a calendaring process, to achieve the target porosity and density of the electrode.

Preferably, the assembly obtained at step (iv) is hot pressed, the temperature during the compression step being comprised from 25° C. and 130° C., preferably being of about 90° C.

Preferred target porosity for the obtained electrode is comprised between 15% and 40%, preferably from 25% and 30%. The porosity of the electrode is calculated as the complementary to unity of the ratio between the measured density and the theoretical density of the electrode, wherein:
the measured density is given by the mass divided by the volume of a circular portion of electrode having diameter equal to 24 mm and a measured thickness; and
the theoretical density of the electrode is calculated as the sum of the product of the densities of the components of the electrode multiplied by their volume ratio in the electrode formulation.

In a further instance, the present invention pertains to the electrode obtainable by the process of the invention.

Therefore the present invention relates to an electrode comprising:
a metal substrate, and
directly adhered onto at least one surface of said metal substrate, at least one layer consisting of a composition comprising:
(a) one or more vinylidene fluoride (VDF) based polymers wherein:
   (i) said VDF based polymers comprise at least 70% by moles of recurring units, based on the total amount of recurring units of said polymers, derived from vinylidene fluoride (VDF);
   (ii) said VDF based polymers comprise less than 0.9% by moles of recurring units, based on the total amount of recurring units of said polymers, comprising a functional group selected from carbonylic, carboxylic, sulfonic, sulfinic, phosphonic, hydroxy, —SH, ester or mixtures thereof;
   (iii) said VDF based polymers have a melting temperature Tm comprised between 130 and 180° C.
   (iv) said VDF based polymers have a total number of chain ends —CF₂H and —CF₂CH₃ as measured via NMR of less than 70 mmoles/Kg
(b) one or more electro-active materials.

The layer of the electrode of the invention typically has a thickness comprised between 10 μm and 500 μm, preferably between 50 μm and 250 um, more preferably between 70 μm and 150 μm.

The electrode-forming composition of the present invention is particularly suitable for the manufacturing of positive electrodes for electrochemical devices.

The electrode of the invention is particularly suitable for use in electrochemical devices, in particular in secondary batteries, comprising said electrode.

For the purpose of the present invention, the term “secondary battery” is intended to denote a rechargeable battery. The secondary battery of the invention is preferably an alkaline or an alkaline-earth secondary battery. The secondary battery of the invention is more preferably a Lithium-ion secondary battery. An electrochemical device according to the present invention can be prepared by standard methods known to a person skilled in the art.

Should the disclosure of any patents, patent applications, and publications which are incorporated herein by reference conflict with the description of the present application to the extent that it may render a term unclear, the present description shall take precedence.

The invention will be now described with reference to the following examples, whose purpose is merely illustrative and not intended to limit the scope of the invention.

### EXPERIMENTAL PART

### Raw Materials

Polymer 1—PVDF homopolymer having Tm=163 ° C., having a number average molecular weight of about 867 kDa, and a number of chain ends —CF₂H and —CF₂CH₃ of 38 mmol/Kg in powder form.

Polymer 2—PVDF homopolymer having Tm=163 ° C., having a number average molecular weight of about 783 kDa, and a number of chain ends —CF₂H and —CF₂CH₃ of 41 mmol/Kg in powder form.

Polymer 3—PVDF homopolymer having Tm=161 ° C., having a number average molecular weight of about 842 kDa, and a number of chain ends —CF₂H and —CF₂CH₃ of 89 mmol/Kg in powder form.

Polymer 4—PVDF copolymer with 1% content of recurring units derived from acrylic acid in powder form. Tm=162° C., having a number average molecular weight of about 900 kDa.

Polymers 1 and 2 have been prepared according to the method described in WO2019002180A1 via emulsion polymerization at 80° C., using a redox initiator system (t-butyl hydroperoxide and 2-hydroxy-2-sulfinatoacetic acid disodium salt), followed by coagulation, washing and drying. Polymer 3 has been prepared with the same method using a standard radical initiator (ammonium persulfate) at a temperature of 105° C. (which is necessary for the non-redox initiator to work). Polymer 4 is available from Solvay Specialty Polymers.

Electroconductivity-imparting additive: Carbon nanotubes NC7000™ from Nanocyl.

Electro-Active material: LiFePO4 having particle size D50 0.5 um, available from Johnson Matthey as Life Power®P2 C-LiFePO₄.

NMP is N-Methyl-2-pyrrolidone 99% from Sigma Aldrich

### Determination of Melting Point

The melting point Tm was measured as second melting temperature via DSC according to ASTM D 3418 standard. The procedure was as follows: Polymer samples were melted heating them from 10 to 230° C. with a temperature ramp of 10° C./min. The samples were then maintained at 230° C. for 5 minutes, and then recrystallized decreasing the temperature from 230° C. to 10° C. with a ramp of 10° C./min. The polymer was then kept 10 min at 10° C. and then heated again to 230° C. with a temperature ramp of 10° C./min. The melting point was determined as the temperature of fusion during this second ramp.

### Chain Ends Determination

The end groups of the polymers were measured by NMR analysis, by recording the NMR spectra at 60° C. on a Varian VNMS 500 NMR spectrometer operating at 499.86 MHz for ¹H and 470.28 MHz for ¹⁹F using a Triple HFCP-PFG probe with 5 mm 502-8 (Norell, Inc.) NMR sample tubes. The NMR experiments were carried out using 40 mg of polymer sample dissolved at 60° C. in 0.75 ml of deuterated acetone (99.9% D, obtained from Sigma-Aldrich) with tetramethylsilane (TMS) used as an internal standard. ¹H was performed using 45 degree pulse length of 5.05 us, 5 s relaxation delay, 2.3 s acquisition time, 16 K complex points, 7 kHz spectral width and 1500 repetitions.

¹⁹F was performed using 45 degree pulse length of 4.44 us, 5 s relaxation delay, 0.695 s acquisition time, 16 K complex points, 23.5 kHz spectral width and 2000 repetitions.

The total number of chain ends (a)+(b) of type:
(a) —CF₂H and
(b) —CF₂CH₃ was measured for the tested polymer in mmoles of chain ends for kilogram of polymer.

The measurement of chain ends and the relative calculation was performed according to the procedure described in “Comprehensive Characterization of Chain End Groups of Vinylidene Fluoride Based Polymers” (Macromol. Symp. 2013, 324, 41-48).

### General Preparation of the Electrode Forming Composition

Compositions were prepared as follows. First 8 g of polymers are added to 92 g of NMP under stirring. 24.5 g of this mixture were stirred for 10 minutes in a centrifugal mixer with 53.62 g of Electro active material, 10.5 g of a 4% by weight dispersion of Carbon nanotubes in NMP, and 11.38 g of additional NMP. The resulting slurry has a total solid content (TSC) of 56% and its composition is as follows:

TABLE 1

| Materials | Net mass/g | Solids composition % w/w |
|---|---|---|
| Polymer | 1.96 | 3.5 |
| Carbon Nanotubes | 0.42 | 0.75 |
| Electro active materials | 53.62 | 95.75 |
| Total solid content | 56 | |
| NMP | 44 | |
| Total mass | 100 | |

The premixes were then mixed using a high speed butterfly impeller at 2000 rpm for 1 hour.

The following Example compositions were prepared:
Ex. 1—According to the general preparation procedure using Polymer 1 as polymer component.
Ex. 2—According to the general preparation procedure using Polymer 2 as polymer component.
Ex. 3c (comparative).—According to the general preparation procedure using Polymer 3 as polymer component.
Ex. 4c (comparative)—According to the general preparation procedure using Polymer 4 as polymer component.

### Physical Stability Test

As mentioned above, electrode forming compositions need to remain spreadable over time in order to be properly stored and used at the appropriate time in manufacturing facilities.

The compositions of examples 1-4 were left in closed vessels for 7 days at 25° C. and then visually checked with the following results:

TABLE 2

| | Solidified |
|---|---|
| Ex. 1 | NO |
| Ex. 2 | NO |
| Ex. 3c | NO |
| Ex. 4c | YES |

The results of the Physical stability test show that the slurry of Ex. 4c was not solidified and not spreadable after storage. The slurry formed a solid gelatinous block which could not be used to prepare an electrode.

### Adhesion Peeling Force Method

The adhesion on Al was measured for all the spreadable slurries obtained in the examples, namely Ex. 1, 2 and 3c. Peeling force could not be measured for Ex. 4c as the slurry is not spreadable and the electrode could not be prepared.

In order to compare the adhesion behavior of the compositions of Ex. 1, 2 and3c electrodes were obtained by casting the compositions on 15 μm thick Al foil with a doctor blade and drying the coating layers so obtained in a vacuum oven at temperature of 90° C. for about 50 minutes. The thickness of the dried coating layers was about 110 μm.

Peeling tests were performed on the electrodes prepared as above described, with the setup described in the standard ASTM D903 at a speed of 300 mm/min at 20° C. in order to evaluate the adhesion of the dried coating layer to the Al foil. The measured values in N/m were normalized with respect to Ex.3c to which an adhesion value of 1 has been assigned. Results obtained are reported in the following table:

TABLE 3

| | Adhesion [N/m] | Normalized Adhesion [%] |
|---|---|---|
| Ex. 1 | 4.49 | 197 |
| Ex. 2 | 3.04 | 134 |
| Ex. 3c | 2.28 | 100 |

The results surprisingly show that the electrodes of Ex. 1 and Ex. 2 prepared by using the combination of VDF based polymers selected according to the teaching of the present invention (with low amount of chain ends following redox polymerization) has a much better adhesion than comparative Ex. 3c prepared using standard VDF based polymers having essentially the same monomer composition, melting temperature and molecular weight (with higher amount of chain ends following standard radical thermal initiator).

Also results from the physical stability test show that compositions according to the invention are stable, while compositions using VDF copolymers comprising polar monomers (commonly employed in electrode forming compositions in order to increase the adhesion of the composition to the metal foil) are not physically stable forming a solid gelatinous block in the particularly stressed conditions of the test (LiFePO₄ active materials is particularly prone to form solid jelly materials when combined with VDF copolymers having a large amount of polar groups).

1. An electrode-forming composition comprising:
(a) one or more vinylidene fluoride (VDF) based polymers wherein:
(i) said VDF based polymers comprise at least 70% by moles of recurring units, based on the total amount of recurring units of said polymers, derived from vinylidene fluoride (VDF);
(ii) said VDF based polymers comprise less than 0.9% by moles of recurring units, based on the total amount of recurring units of said polymers, comprising a functional group selected from carbonylic, carboxylic, sulfonic, sulfinic, phosphonic, hydroxy, —SH, ester or mixtures thereof;
(iii) said VDF based polymers have a melting temperature Tm comprised between 130 and 180° C.
(iv) said VDF based polymers have a total number of chain ends —CF₂H and —CF₂CH₃ as measured via NMR of less than 70 mmoles/Kg; and
(b) one or more electro-active materials.

2. The electrode forming composition according to claim 1 further comprising:
(c) one or more organic solvent.

3. The electrode forming composition according to claim 1 wherein said one or more VDF polymers have a number of chain ends —CF₂H and —CF₂CH₃ as measured via NMR of less than 60 mmoles/Kg.

4. The electrode forming composition according to claim 1 wherein said one or more VDF based polymers comprise at least 80%, by moles of recurring unites derived from VDF, based on the total amount of recurring units of said polymers, and comprise less than 0.9% by moles, based on the total amount of recurring units of said polymers of recurring units derived from monomers comprising a functional group selected from carbonylic, carboxylic, sulfonic, sulfinic, phosphonic, hydroxy, —SH, ester or mixtures thereof.

5. The electrode forming composition according to claim 1 comprising:
from 0.5% by weight to 10% by weight of said one or more VDF based polymers;
from 80% by weight to 99% by weight, of said at least one electro active material, all percentages being weight percentages with respect to the total solid content of the electrode forming composition.

6. The electrode forming composition according to claim 1 wherein said one or more electro-active material comprises one or more compounds selected from:
(i) metal chalcogenides of formula LiMQ₂, wherein M is selected from transition metals, and Q is a chalcogen;
(ii) lithiated or partially lithiated transition metal oxyanion-based electro-active materials of formula:
M1M2(JO₄)_{f}E_{(1-f)}
wherein
M1 is lithium, optionally partially substituted by one or more other alkali metal, said one or more other alkali metal representing less than 20% of the total of M1 metals,
M2 is a transition metal at the oxidation number of +2 selected from Fe, Mn, Ni or mixtures thereof, said transition metal optionally being partially substituted by one or more additional metals at oxidation number between +1 and +5, said one or more additional metals representing less than 35% of the total of M2 metals,
JO₄ is any oxyanion wherein J is selected from P, S, V, Si, Nb, Mo or a combination thereof,
E is a fluoride, hydroxide or chloride anion, or mixtures thereof
“f” is the molar fraction of the JO4 oxyanion, and is comprised between 0.75 and 1;
(iii) lithium-containing complex metal oxides of general formula:
LiNiₓM1_{y}M2_{z}Y₂
wherein:
M1 and M2 are the same or different from each other and are transition metals selected from Co, Fe, Mn, Cr and V, or mixtures thereof,
0.5 ≤ x ≤ 1, and y+z =1-x,
Y is a chalcogen, preferably selected from O and S or mixtures thereof.

7. The electrode forming composition according to claim 1 wherein said one or more electro-active materials comprises a phosphate-based electro-active material of formula:
Li(FeₓMn₍₁₋ₓ₎)PO₄ wherein 0≤x≤1.

8. The electrode forming composition according to claim 1 wherein said one or more electro-active materials comprises lithium iron phosphate of formula LiFePO₄.

9. The electrode forming composition according to claim 1 wherein said VDF polymer has been obtained via polymerization in an aqueous emulsion of vinylidene fluoride and optionally of other monomers, in the presence of a redox-initiating system comprising at least one organic radical initiator as oxidizing agent and at least one sulphur based reducing agent.

10. The electrode forming composition according to claim 8 wherein said sulphur based reducing agent comprises at least a compound bearing a sulfinic group in its acid or salt form.

11. An The electrode forming composition according to claim 10 wherein said compound bearing a sulfinic group in its acid or salt form corresponds to the following general formula (S-I): 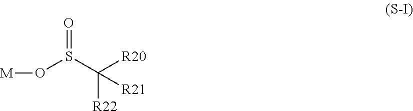
wherein
R20 is selected from —OH or —N(R⁴)(R⁵),
R21 is selected from —H, linear or branched alkyl groups having from 1 to 6 carbon atoms, 5- or 6-membered cycloalkyl groups, 5-or 6-membered aryl groups;
R22 is selected from —COOM, —SO₃M, —C(═O)R₄, —C(═O)N(R⁴)(R⁵), —C(═O)OR₄, and wherein:
M is selected from a hydrogen atom, an ammonium ion, a monovalent metal ion;
R⁴ and R⁵ are independently selected from -H and linear or branched alkyl groups having from 1 to 6 carbon atoms.

12. An The electrode forming composition according to claim 10 wherein said compound bearing a sulfinic group is 2-hydroxy-2-sulfinatoacetic acid or its disodium salt.

13. A process for the manufacture of an electrode, said process comprising:
(i) providing a metal substrate having at least one surface;
(ii) providing an electrode-forming composition according to claim 1;
(iii) applying the composition provided in step (ii) onto the at least one surface of the metal substrate provided in step (i), thereby providing an assembly comprising a metal substrate coated with said composition onto the at least one surface; and
(iv) drying the assembly provided in step (iii).

14. An electrode obtainable by the process according to claim 13 said electrode comprising:
a metal substrate, and
directly adhered onto at least one surface of said metal substrate, at least one layer consisting of a composition comprising:
(a) one or more vinylidene fluoride (VDF) based polymers wherein:
(i) said VDF based polymers comprise at least 70% by moles of recurring units, based on the total amount of recurring units of said polymers, derived from vinylidene fluoride (VDF);
(ii) said VDF based polymers comprise less than 0.9% by moles of recurring units, based on the total amount of recurring units of said polymers, comprising a functional group selected from carbonylic, carboxylic, sulfonic, sulfinic, phosphonic, hydroxy, —SH, ester or mixtures thereof;
(iii) said VDF based polymers have a melting temperature Tm comprised between 130 and 180° C.
(iv) said VDF based polymers have a total number of chain ends —CF₂H and —CF₂CH₃ as measured via NMR of less than 70 mmoles/Kg (b) one or more electro-active materials.

15. An electrochemical device comprising at least one electrode according to claim 14.

16. The electrode forming composition according to claim 1 wherein said one or more VDF polymers have a number of chain ends —CF₂H and —CF₂CH₃ as measured via NMR of less than 50 mmoles/Kg.

17. The electrode forming composition according to claim 1 wherein said one or more VDF based polymers comprise at least 90% by moles of recurring unites derived from VDF, based on the total amount of recurring units of said polymers, and comprise less than 0.6% by moles, based on the total amount of recurring units of said polymers, and are free from recurring units derived from monomers comprising a functional group selected from carbonylic, carboxylic, sulfonic, sulfinic, phosphonic, hydroxy, —SH, ester or mixtures thereof.

18. The electrode forming composition according to claim 1 comprising:
from 0.7% by weight to 5% by weight of said one or more VDF based polymers;
from 80% by weight to 99% by weight, of said at least one electro active material, all percentages being weight percentages with respect to the total solid content of the electrode forming composition.

19. The electrode forming composition according to claim 6, wherein M is selected from transition metals Co, Ni, Fe, Mn, Cr, and V, or mixtures thereof, and Q is a chalcogen selected from O, or S, or mixtures thereof.

20. The electrode according to claim 14, wherein the electrode is a cathode.
